(19) United States
(12) Patent Application Publication
(10) Pub. No.: US 2008/0159116 A1
(43) Pub. Date: Jul. 3, 2008

(54) Method for Producing Optical Recording Medium

(75) Inventor: Hiroshi Kubo, Tokyo (JP)

Correspondence Address: TAIYO CORPORATION, 401 HOLLAND LANE, #407, ALEXANDRIA, VA, 22314, US

(73) Assignee: FUJIFILM Corporation, Tokyo (JP)

(21) Appl. No.: 11/886,122

(22) PCT Filed: Apr. 13, 2006
(86) PCT No.: PCT/JP2006/308252

§ 371 Date: Sep. 11, 2007

(30) Foreign Application Priority Data
Apr. 13, 2005 (JP) 2005-115869
Jul. 29, 2005 (JP) 2005-222123

(51) Int. Cl. G11B 7/24

(52) U.S. Cl. 369/275.4

(57) ABSTRACT

A method for producing an optical recording medium having a substrate and a reflective layer, a recording layer and a cover layer formed in this order on the substrate, the method including forming guide grooves or pits at the substrate, forming the reflective layer at a surface side of the substrate on which the guide grooves or pits are formed, forming the recording layer by forming a film on the cover layer, and bonding the reflective layer of the substrate and the recording layer of the cover layer.

### TECHNICAL FIELD

The present invention relates to a method for producing an optical recording medium used for computers, business, and by consumers.

### BACKGROUND ART

Recently, networks such as the Internet, and high-vision television have undergone rapid dissemination. Broadcasts of high-definition vision (HDTV) have also been launched. In these circumstances, optical recording media with large capacity on which image information can be cheaply and easily recorded are necessary. While Digital Versatile Disks (DVD-R) are currently serving adequately as high capacity optical recording media, further development of optical recording media is required in order to respond to increasing demands for higher capacity and higher density. As a result, development of higher capacity optical recording media that can perform high density recording with light having shorter wavelengths is proceeding apace.

For example, for optical recording media having a recording layer including an organic dye, recording and reproduction methods for recording and reproducing information by irradiating laser beam with a wavelength of 530 nm or less from the recording layer side to a reflective layer side have been disclosed (see, for example, Japanese Patent Application Laid-Open (JP-A) Nos. 4-74690, 7-304256, 7-304257, 8-127174, 11-53758, 11-334204, 11-334205, 11-334206, 11-334207, 2000-43423, 2000-108513, 2000-113504, 2000-149320, 2000-158818 and 2000-228028).

These methods involve recording or reproduction of information by irradiation of blue laser beam (wavelength 430 nm, 488 nm) or blue-green laser beam (wavelength 515 nm) onto an optical recording layer provided with a recording layer including a porphyrin compound, an azo dye, a metal azo dye, a quinophthalon dye, a trimethyncyanine dye, a dicyanovinylphenyl skeleton dye, a coumarin compound, a naphthalocyanine compound or the like.

Further, in consideration of compatibility with CD-R systems currently in use, optical recording media that can record and reproduce information with laser beam of two different wavelength ranges have been proposed.

For example, optical recording media that can record and reproduce with either laser beam in the near-infrared range in the vicinity of 780 nm or visible laser beam in the vicinity of 650 nm by using a mixture of dye used in CD-Rs with dye used in DVD-Rs, have been proposed (see, for example, JP-A Nos. 2000-14190, 2000-158816, 2000-185471, 2000-289342 and 2000-309165).

However, when information is recorded using the optical recording media disclosed in the above publications by irradiation of laser beam with short wavelengths of 600 nm or less or, in particular, 450 nm or less, it is difficult to obtain the sensitivity required for practical application or it is difficult to achieve other recording properties such as reflectivity or modulation depth to a satisfactory level. In particular, with the optical recording media disclosed in the above publications, there is a concern that recording properties are decreased when laser beam of 450 nm or less is irradiated.

In existing optical recording media, laser beam has generally been incident from the substrate side. However, pick ups using short wavelength light and an objective lens with a high numerical aperture (NA) have come to be used in order to achieve higher density. An example of this is the DVR-blue (ODS 2001 Technical Digest, pp. 139-141) which combines blue-violet laser beam in the region of 405 nm and an objective lens of NA 0.85. In an optical recording medium using this kind of short wavelength and high NA optical system, the influence of coma aberration due to disk warping is too large to ignore.

In order to eliminate the influence of coma aberration, recording and reproduction defects due to coma aberration have been alleviated by having laser beam for recording and reproduction incident through a cover layer having a thickness of about 0.1 mm, which is significantly thinner than conventional substrates (for example, a thickness of 1.2 mm for a CD or a thickness of 0.6 mm for a DVD).

For this kind of optical recording medium, for example, a rewritable phase change type optical recording medium, the medium structure used is, in order from the laser beam incident surface side: cover layer/(transparent adhesive layer)/dielectric layer/recording layer/dielectric layer/reflective layer/substrate (there are cases when the above cover layer and the above transparent adhesive layer are formed integrally from ultraviolet photocurable resin by spin coating).

In the case of a DVR-blue, the combined thickness of the cover layer and the transparent adhesive layer is approximately 0.1 mm and the thickness of the substrate is approximately 1.1 mm.

On the other hand, the medium structure of a dye-type recordable optical recording layer is generally, in order from the laser beam incident surface side, substrate/recording layer/reflective layer/protective layer for a CD-R and substrate/recording layer/reflective layer/(protective layer)/adhesive layer/(protective layer)/(reflective layer)/substrate for DVD-R. Further, in the case of a DVD-R, the above layers in parentheses are sometimes omitted.

If this structure were to be applied to the optical recording medium having a cover layer described above, the following structure is conceivable: cover layer/(transparent adhesive layer)/transparent blocking layer/recording layer/reflective layer/substrate. The transparent blocking layer is a transparent thin film layer formed by sputtering or the like in order to prevent damage to the dye layer (recording layer) caused by dye leaking out from the dye layer in cases when a transparent adhesive layer of ultraviolet photocurable resin or the like is coated on the dye layer. A dielectric layer of ZnS, SiO₂, ZnO.Ga₂O₅ or the like is used as the transparent blocking layer.

However, formation of the dielectric layer incurs film forming costs and may damage the dye layer. Further, problems exist such as potential impairment of recording properties by the formation of a new interface.

Another method involves bonding a transparent cover layer with double-sided adhesive tape (including cases when there is no support). However, this method incurs high costs and problems exist such as impairment of optical properties by the adhesive layer.

With manufacturing methods for the above optical recording media, since it is necessary to form a recording layer on the substrate in each case, film forming methods such as sheet-type sputtering, spin coating or the like are used, and the problem exists that film forming costs increase during mass production.

### DISCLOSURE OF THE INVENTION

In view of the above, the present invention has been devised in order to address problems in the existing art and provides a method of producing an optical recording medium at low cost with superior productivity.

A first aspect of the present invention is a method for producing an optical recording medium comprising a substrate and a reflective layer, a recording layer and a cover layer formed in this order on the substrate, wherein the method comprises: forming guide grooves or pits on the substrate, forming the reflective layer at a surface side of the substrate on which the guide grooves or pits are formed, forming the recording layer by forming a film on the cover layer, and bonding the reflective layer of the substrate and the recording layer of the cover layer.

A second aspect of the present invention is the method for producing an optical recording medium according to the first aspect, wherein the bonding is performed in any one atmosphere of a vacuum atmosphere, a reduced pressure atmosphere, a reduced pressure nitrogen atmosphere, or a reduced pressure inert gas atmosphere.

A third aspect of the present invention is the method for producing an optical recording medium according to the first or second aspect, wherein the film forming of the recording layer is performed by web coating.

A fourth aspect of the present invention is the method for producing an optical recording medium according to the first or second aspect, wherein the film forming of the recording layer is performed by web coating.

A fifth aspect of the present invention is the method for producing an optical recording medium according to any one of the first to fourth aspects, wherein the guide grooves or pits are formed on one surface of the substrate.

A sixth aspect of the present invention is the method for producing an optical recording medium according to any one of the first to fourth aspects, wherein the guide grooves or pits are formed on both surfaces of the substrate and the forming of the guide grooves or pits is performed simultaneously on both surfaces.

A seventh aspect of the present invention is the method for producing an optical recording medium according to any one of the first to sixth aspects, wherein the bonding is performed by bonding an inner circumferential portion and an outer circumferential portion of the cover layer without bonding a data-recording area.

An eighth aspect of the present invention is the method for producing an optical recording medium according to any one of the first to sixth aspects, wherein the bonding is performed by forming an adhesive layer on the recording layer at the side of the cover layer and adhering the adhesive layer to a side of the substrate on which the reflective layer is formed.

A ninth aspect of the present invention is the method for producing an optical recording medium according to any one of the first to sixth aspects, wherein the bonding is performed after a dielectric layer is provided on the recording layer at the side of the cover layer.

A tenth aspect of the present invention is the method for producing an optical recording medium according to the eighth aspect, wherein the bonding is performed after providing a dielectric layer on the adhesive layer.

An eleventh aspect of the present invention is a method for producing an optical recording medium comprising a substrate and at least a recording layer and a cover layer formed in this order on the substrate, wherein the method comprises: simultaneously forming guide grooves or pits on one surface of the substrate and pits on another surface of the substrate, forming the recording layer by forming a film on the cover layer, bonding the cover layer on which the recording layer is formed to one surface side of the substrate such that the recording layer is an internal layer and bonding a cover layer on which no recording layer is formed to another surface side of the substrate.

A twelveth aspect of the present invention is the method for producing an optical recording medium according to the eleventh aspect, wherein at least the bonding is performed in any one atmosphere of a vacuum atmosphere, a reduced pressure atmosphere, a reduced pressure nitrogen atmosphere, or a reduced pressure inert gas atmosphere.

A thirteenth aspect of the present invention is the method for producing an optical recording medium according to the eleventh or twelveth aspect, wherein the film forming of the recording layer is performed by web coating.

A fourteenth aspect of the present invention is the method for producing an optical recording medium according to the eleventh or twelveth aspect, wherein the film forming of the recording layer is performed by web vacuum deposition or sputtering.

### BRIEF DESCRIPTION OF THE DRAWINGS

FIG. 1 is an explanatory diagram illustrating part of a process of the method of production according to the present invention, where (A) shows a recording layer forming process, (B) shows cover layers after stamping, and (C) shows a bonding process.

FIG. 2 is a partial sectional view showing an example for a layer structure of an optical recording medium produced according to the method of the present invention.

FIG. 3 is a partial sectional view showing another example of the layer structure of an optical recording medium produced according to the method of the present invention.

### BEST MODE FOR CARRYING OUT THE INVENTION

In the following, the method for producing an optical recording medium according to the present invention is explained in detail with reference to the drawings. Method for producing an optical recording medium of the present invention As a first embodiment of the present invention, a first method for producing an optical recording medium is a method for producing an optical recording medium formed from a reflective layer, a recording layer and a cover layer in this order on a substrate that comprises a groove forming process of forming guide grooves or pits on a substrate, a subsequent reflective layer forming process of forming a reflective layer at the side of the substrate on which the guide grooves or pits are formed, a recording layer forming process of forming a recording layer by forming a film on the cover layer, and an bonding process of bonding the reflective layer of the substrate and the recording layer of the cover layer.

The above first method of production is different from previous methods according to which a reflective layer, a recording layer and a cover layer are sequentially formed on a substrate, in that a substrate on which a reflective layer or the like is formed and a cover layer on which a recording layer is formed are produced separately and then bonded together. In previous methods according to which a recording layer and a cover layer or the like are sequentially formed on a substrate, recording layers must be formed on single disk substrates one-by-one. Accordingly, the problem exists that film forming costs for mass production are high.

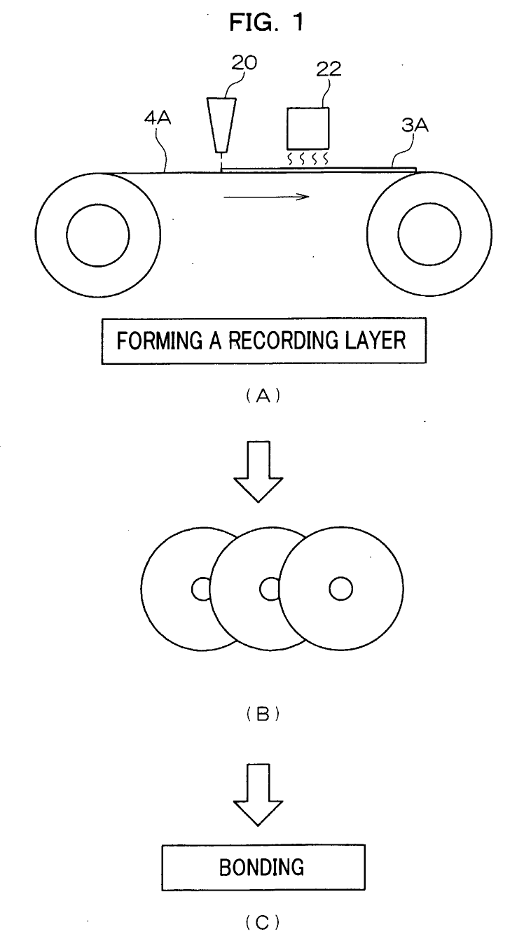

However, in the present invention, as shown in the recording layer forming process (A) in FIG. 1, a cover layer on which a recording layer is formed is produced by continuously forming a coating film 3A (recording layer) on a cover sheet 4A (cover layer). This formation method is preferably performed by web coating, web vacuum deposition, or web sputtering in view of the fact that continuous treatment is possible. In the case of web coating, as shown in the recording layer forming process (A) in FIG. 1, it is preferable that a coating device 20 is provided at an upstream side and a drying device 22 is provided at a downstream side. Then, an optical recording medium can be produced by stamping the cover layer to make it the same shape as the substrate as shown in (B) in FIG. 1, bonding it to the reflective layer (bonding process (C) in FIG. 1) and stamping to a predetermined shape after the cover layer is bonded to the reflective layer of the substrate. This kind of method of producing an optical recording medium is preferable in terms of mass productivity and low film forming costs during mass production since there is no need to form recording layers one-by-one on separate disk substrates.

Further, the recording layer and the cover layer of the optical recording medium produced thus are respectively planar, are in mutual contact across the entire mutually contacting respective surfaces thereof, and respectively have substantially uniform thickness. Accordingly, since the recording layer is planar and substantially uniform, an optical recording medium having this kind of recording layer can reduce variation of modulation amplitude along the radial direction and the circumferential direction and can increase reliability by broadening the margin of signal error. Here, “planar” refers to a shape such that the thickness of the recording layer is substantially uniform and that hardly reflects the shape of the grooves formed on the substrate.

In the following, the method for producing an optical recording medium according to the present invention is explained by explaining in detail the component elements of the substrate and respective layers.

### Substrate Having a Reflective Layer or the Like Formed Thereon

For the substrate, each kind of material used as substrate material in conventional optical recording media may be optionally selected and used.

Specific examples of the substrate include glass; acrylic resins such as polycarbonate or polymethylmethacrylate; vinyl chloride based resins such as polyvinyl chloride or vinyl chloride copolymers; epoxy resins; amorphous polyolefin; polyester; metals such as aluminum; or combinations or any of these as desired.

Among the above materials, polycarbonate and amorphous polyolefin are preferable, and polycarbonate is particularly preferable, in view of moisture resistance, dimensional stability low cost and the like. Further, it is preferable that the thickness of the substrate is 0.1-1.2 mm, more preferably, 0.3-1.2 mm in view of maintenance of strength, prevention of warping, ease of handling and the like.

As described above, guide grooves or pits for tracking are formed on the substrate. Here, “guide grooves” refer to grooves that contain information such as address signals and, in the following, “grooves” refer to “on-grooves and in-grooves”. It is preferable that the substrate used has grooves formed thereon at a narrower track pitch than CD-Rs or DVDs in order to achieve higher recording density. The track pitch of the grooves is preferably in the range of 200-400 nm and, more preferably, in the range of 250-350 nm. Further, the depth of the in-grooves (groove depth) is preferably in the range of 20-150 nm and, more preferably, in the range of 25-80 nm. The pits or guide grooves may be formed according to the conventional moulding (injection moulding) method (groove forming process).

The surface of the substrate on which the grooves or pits are formed may have convex shape and the thickness ratio D (thinnest portion of the substrate/thickest portion of the substrate) of the thickest potion of the substrate to the thinnest portion of the substrate is in the range of from 0.5<D<1 and more preferably in the range of 0.8<D<0.9.

Further, the surface on which the guide grooves or pits are formed in the groove forming process may be one surface of the substrate or both surface of the substrate, and the formation of the guide grooves or pits may be performed at both surfaces simultaneously.

For the reflective layer formed if desired at the surface of the substrate on which the grooves are formed, a light reflective material with high reflectivity of laser beam is used. Examples of the light reflective material with high reflectivity include metals and metalloids such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn, and Bi, and stainless steel. These light reflective materials may be used singly or in combination of two or more types thereof. Among these, preferable materials are Cr, Ni, Pt, Cu, Ag, Au, Al and stainless steel. Au, Ag, and Al or alloys of these are particularly preferable, and Au and Ag or an alloy thereof are most preferable.

The reflective layer can be formed on the substrate by, for example, vapor depositing, sputtering or ion plating the light reflective material (reflective layer forming process). The layer thickness of the reflective layer is generally 10-300 nm and preferably 50-120 nm. A substrate having on which a reflective layer or the like is formed is produced as above. Further, an optical disk configuration is normal as the optical recording medium; however, a card-type configuration or a sheet-type or tape-type configuration according to the thickness of the substrate can also be applied.

### Cover Film

The material used for the cover film constituting the cover layer is not particularly limited as long as it is transparent with respect to the laser beam used, but is preferably a material with a moisture absorption coefficient of 5% at 23° C. 50% RH and is more preferably polycarbonate, cellulose triacetate, amorphous polyolefin or the like.

Here, “transparent” means transparent to the extent that recording light and reproduction light transmits therethrough (a transmittance rate of 85% or above).

The thickness of the cover layer is preferably in the range of 3-130 μm, more preferably in the range of 30-130 μm, and still more preferably in the range of 50-110 μm in view of resistance to dust adhesion, scratch resistance and reduction of coma aberration.

The recording layer formed on the cover layer is at least capable of recording information from laser beam with a wavelength of 450 nm or less, and at least includes a dye as the recording material. Examples of the dye contained in the recording layer include at least one kind of metallic complex series dye, azo dye, benzotriazole dye, or phthalocyanine dye and, among these, a phthalocyanine dye is preferable. Further, the recording layer can be either rewritable or recordable; however, it is preferably recordable. Recording does not have to be heat mode recording and can be photon mode recording.

Further, the dyes described in Japanese Patent Application Laid-Open (JP-A) Nos. 4-74690, 8-127174, 11-53758, 11-334204, 11-334205, 11-334206, 11-334207, 2000-43423, 2000-108513 and 2000-158818 can favorably be used.

In the present invention, the recording layer is a layer for recording or reproducing of information by a laser beam used in recording and reproduction. In particular, coded information such as digital information is recorded. The recording layer may be a dye recording layer or a phase change type recording layer; however, a dye recording layer is preferable.

Specific examples of the dye contained in the dye recording layer include cyanine dye, oxonol dye, azo dye, phthalocyanine dye, triazol dye (including benzotriazole compounds), triazine compounds, merocyanine compounds, aminobutadiene compounds, cinnamic acid compounds, benzoxazole compounds, pyrromethene compounds and squarylium compounds. Further, these may have a metal atom at the coordinate centers thereof.

Further, the dyes taught by JP-A Nos. 4-74690, 8-127174, 11-53758, 11-334204, 11-334205, 11-334206, 11-334207, 2000-43423, 2000-108513 and 2000-158818 can be used. Among the above compounds, cyanine dye, oxonol dye, azo dye, phthalocyanine dye, benzotriazole compounds and triazine compounds can favorably be used as the dye recording layer. Among the above compounds, cyanine dye, oxonol dye, azo dye and phthalocyanine dye are particularly preferable. Having the dye as any of the above dyes enables realization of favorable recording and reproduction properties and storage stability.

The recording layer is formed by dissolving a recording material such as a dye in a suitable solvent to prepare a coating solution, coating the coating liquid on the cover film to form a coating film, and then drying as necessary (recording layer forming process).

Methods such as web coating or continuous vapor deposition of cover film are preferably applied as coating methods for the coating solution. Methods such as web coating or continuous vapor deposition enable efficient formation of a recording layer of a substantially uniform thickness. Further, since recording layers can be continuously formed by such methods, these methods are superior in mass productivity and it is possible to reduce the occurrence of defective products with non-uniform thickness, and it is thus possible to improve productivity compared to recording film formation methods by, for example, spin coating or deep coating on a one-by-one basis. Further, as already described, a sputtering method may be applied.

The concentration of the recording material in the coating solution is generally in the range of 0.01-15 mass percent, preferably in the range of 0.1-10 mass percent, more preferably in the range of 0.5-5 mass percent, and most preferably in the range of 0.5-3 mass percent.

Examples of the solvent in the coating solution include: esters such as butyl acetate, ethyl lactate and cellosolve acetate; ketones such as methyl ethyl ketone, cyclohexanone and methyl isobutyl ketone; chlorinated hydrocarbons such as dichloromethane, 1,2-dichloroethane and chloroform; amides such as dimethylformamide; hydrocarbons such as methylcyclohexane; ethers such as tetrahydrofuran, ethyl ether and dioxane; alcohols such as ethanol, n-propanol, isopropanol and n-butanol diacetone alcohol; fluorine solvents such as 2,2,3,3-tetrafluoropropanol; and glycol ether type solvents such as ethylene glycol monomethyl ether, ethylene glycol monoethyl ether and propylene glycol monomethyl ether.

Taking into account the solubility of the recording material used, the above solvents may be used singly or in combination of two or more thereof. In addition, additive agents such as an oxidation inhibitor, ultraviolet absorbent, plasticizer, and lubricant may be added to the coating solution according to the application thereof.

A binding agent may be used according to one embodiment of the present invention. Examples of the binding agent include natural organic high molecular substances such as gelatin, cellulose derivatives, dextran, rosin and rubber; and synthetic organic polymers, for example, hydrocarbon resins such as polyethylene, polypropylene, polystyrene and polyisobutylene; vinyl resins such as polyvinyl chloride, polyvinylidene chloride and polyvinyl chloride/polyvinyl acetate copolymers; acrylic resins such as polymethylacrylate and polymethylmethacrylate; initial condensation products of heat-curable resins such as polyvinyl alcohol, chlorinated polyethylene, epoxy resin, butyral resin, rubber derivatives, and phenol/formaldehyde resins. When a binding agent is incorporated as a material for the recording layer, the amount of binding agent used is generally in the range of 0.01-50 parts (mass ratio) with respect to the recording material, and is preferably in the range of 0.1-5 parts. The concentration in the coating solution of the recording material prepared thus is generally in the range of 0.01-10 mass percent and is preferably in the range of 0.1-5 mass percent.

The thickness of the recording layer is generally in the range of 20-500 nm, preferably in the range of 30-300 nm and more preferably in the range of 25-80 nm.

Various kinds of anti-fading agents are preferably included in the recording layer in order to improve the light resistance of the recording layer.

A singlet oxygen quencher is generally used as an anti-fading agent. A conventionally known singlet oxygen quencher disclosed in publications such as patent specifications can be used.

Specific examples thereof include those disclosed in JP-A Nos. 58-175693, 59-81194, 60-18387, 60-19586, 60-19587, 60-35054, 60-36190, 60-191, 60-44554, 60-44555, 60-44389, 60-44390, 60-54892, 60-47069, 63-209995 and 4-25492, Japanese Patent Application Publication (JP-B) Nos. 1-38680 and 6-26028, the specification of German Patent No. 350339, and Nippon Kagakukaishi (Journal of the Chemical Society of Japan) No. 10, 1992, p. 1141.

The amount used of the anti-fading agent such as the singlet oxygen quencher is usually in the range of 0.1-50 mass percent, preferably in the range of 0.5-45 mass percent, more preferably in the range of 3-40 mass percent, and particularly preferably in the range of 5-25 mass percent, with respect to the amount of the dye.

A cover film on which a recording layer is formed is manufactured as above.

Subsequently, the substrate on which a given reflective layer is formed and the cover film on which a recording layer is formed obtained as above are bonded together. The method of bonding is not particularly limited, but can be chosen from methods such as the following (1)-(3).
(1) The first method is a method of not necessarily providing an adhesive layer and, for example, mechanically joining the innermost circumferential portion and the outermost circumferential portion.
(2) The second method is a method of coating an adhesive agent (including a pressure-sensitive adhesive agent in the specification of the present application) on the recording layer at the side of cover layer to form an adhesive layer, and then bonding the adhesive layer to the side of the substrate on which the given reflective layer is formed or bonding both together via a pressure-sensitive adhesion sheet instead of an adhesive layer.
(3) The third method is a method of, in the second method, providing a dielectric layer (also known as a transparent block layer or a barrier layer) on the recording layer (if an adhesive layer has been formed, on the adhesive layer) at the cover layer side and bonding both together.

Here, the transparent block layer that is a dielectric layer may be a material such as an oxide, a nitride, a carbide or a sulfide composed of at least one of Zn, Si, Ti, Te, Sm, Mo, Ge, and the like, which may be hybridized in the manner of ZnS—SiO₂. There are no particular limitations on the dielectric body that can be used as the transparent block layer as long as the material has a transmission rate of 90% or above at laser wavelengths. The thickness of the transparent block layer is preferably 1-100 nm and more preferably 1-10 nm.

In the following, the bonding of the substrate on which a given reflective layer is formed to the cover film on which a recording layer is formed is explained in detail. First, the adhesive agent is dissolved in a suitable solvent to prepare a coating solution. The prepared coating solution is coated on the recording layer of the cover film that has been formed by performing web coating or the like. The coating method applied is preferably a method such as curtain coating or spray coating.

Then, the surface of the substrate on which the grooves are formed, or the surface of the substrate on which the reflective layer is formed is attached to the coated surface. Then, the substrate and the cover film are bonded together by irradiating light from above the cover film or applying heat or the like to harden the adhesive agent. Further, when hardening by irradiation of light, it is possible to irradiate from the substrate side when there is no reflective layer. In addition, it is preferable to stamp out the cover film after coating so as to be substantially the same size as the substrate prior to bonding it to the substrate.

It is preferable to conduct the bonding of the substrate and the cover film under various atmospheres such as atmospheric pressure, a vacuum atmosphere, a reduced pressure atmosphere, a reduced pressure nitrogen atmosphere, or a reduced pressure inert gas atmosphere.

Here, reduced pressure means less than atmospheric pressure and is preferably approximately 0.3−10⁻⁵ Torr (39.9−1.33×10⁻³ Pa).

The optical recording medium of the present invention is produced as above. According to the method of production of the present invention, film forming costs during mass production can be reduced because it is not necessary to form recording layers on substrates on a one-by-one basis. Further, since attachment by adhesion to the substrate is possible, materials costs can be reduced to decrease overall costs. In addition, because attachment to the substrate is carried out after the recording layer is formed on the cover film, it is possible to efficiently form a planar recording layer of substantially uniform thickness. Moreover, since the above manufacturing method is merely an example, it is possible to add a variety of changes thereto within the realm of known techniques and those that can be easily performed by one skilled in the art.

While it is possible to use a variety of photocurable resins as the material constituting the adhesive agent, it is preferable to use a pressure sensitive adhesive agent. An acrylate resin can be used as the pressure sensitive adhesive agent. It is preferable to add an isocyanate curing agent to the pressure sensitive adhesive agent.

Further, when a photocurable resin is used as the adhesive agent, it is preferable to use a resin with a low hardening contraction ratio in order to prevent warping of the disk. Ultra-violet photocurable resins are preferable for this kind of photocurable resin, and specific examples thereof include ultra-violet photocurable resins (ultra-violet photocurable adhesives) manufactured by Dainippon Ink & Chemicals, Inc. such as SD-640, SD-347 and SD-318.

Further, the thickness of the adhesive layer is preferably in the range of 1-1000 nm, more preferably in the range of 2-100 nm, and particularly preferably in the range of 3-50 nm, in order to preserve flexibility.

In order to control viscosity, the coating temperature is preferably in the range of 23-50° C., more preferably in the range of 24-50° C., and yet more preferably in the range of 25-37° C.

In order to prevent warping of the disk, it is preferable to perform irradiation of ultra-violet light onto the coating film using a pulse-type light irradiation device (preferably an ultra-violet light irradiation device). The light irradiation amount per 1 pulse is not particularly limited; however, 3 kW/cm² or below is preferable, and 2 kW/cm² or below is more preferable.

The number of times of irradiation is not particularly limited; however, 20 times or less is preferable and 10 times or less is more preferable.

A second method of producing an optical recording medium according to the present invention is a method of producing an optical recording medium formed from at least a recording layer, a cover layer formed in this order on a substrate that comprises a groove forming process of simultaneously forming either guide grooves or pits at one surface of the substrate and pits at the other surface, a recording layer forming process of forming a recording layer by forming a film on a cover layer, and an bonding process of bonding the cover layer on which the recording layer is formed to one surface at the side of the substrate that has undergone the groove forming process such that the recording layer is an internal layer and bonding a cover layer on which a recording layer is not formed to the other surface at the side of the substrate.

The above groove forming process, recording layer forming process and bonding process are the same as in the first method of production. According to this method a double-sided optical recording medium is produced at one surface of which information can be recorded and at the other surface of which information is already recorded.

### Optical Recording Medium

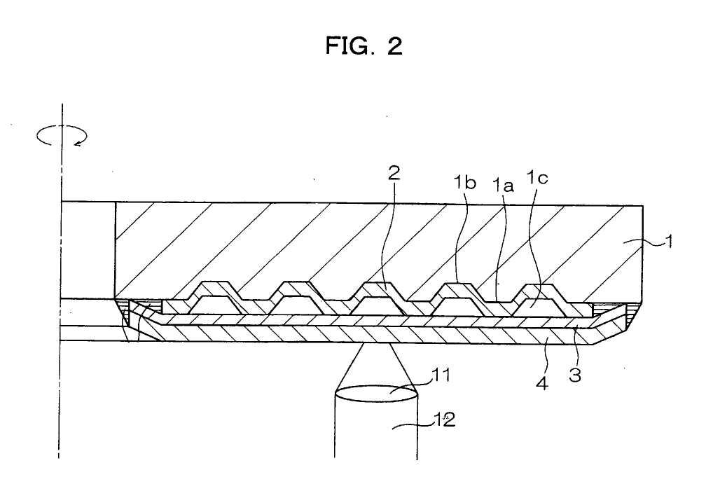

The optical recording medium produced according to the first method of production is structured, for example, as shown in FIG. 2. As shown in FIG. 2, it is structured such that guide grooves (on-grooves 1a and in-grooves 1b) are formed at one surface of a substrate 1, a reflective layer 2 is formed at the surface of the substrate on which the on-grooves 1a and in-grooves 1b are formed, and a cover layer 4 on which a recording layer 3 is formed is bonded by an adhesive layer 5. In this structure of the optical recording medium, the recording layer is planar and contacts the cover layer at the whole contacting surface thereof, the recording layer contacts the on-grooves, and information is recorded at the recording layer where it contacts the on-grooves or opposes the in-grooves.

Here the on-grooves 1a are referred to as convexly formed portions (see FIG. 2) when viewed from the direction from which a laser beam 12 is irradiated to the cover layer via an objective lens 11. The in-grooves 1b are referred to as concavely formed portions (see FIG. 2) when viewed from the same direction. Further, the on-grooves 1a or the in-grooves 1b form a recording portion.

The thickness of the recording layer 3 is substantially uniform. Because the thickness is substantially uniform, variation of modulation amplitude along the radial direction and the circumferential direction can be reduced, the margin of signal error broadened and reliability increased. Further, as discussed below, it is possible to increase productivity by making the thickness substantially uniform.

Here, “substantially uniform” means that when the average thickness is Ta, the thickness (Tmax) of the thickest portion of one disk is in the range of Ta≦Tmax≦1.03Ta (preferably Ta≦Tmax≦1.02Ta), while the thickness Tmin of the least thin portion of the disk is in the range of 0.97Ta≦Tmin≦Ta (preferably 0.98Ta≦Tmin≦Ta). It is possible to reduce variation of modulation amplitude along the radial direction by keeping the thickness within the above range.

Further, as shown in FIG. 2, the optical recording medium of the present invention may be structured by forming a reflective layer 2, with a shape corresponding to the in-grooves 1b and the on-grooves 1a of the substrate 1, between the substrate 1 and the recording layer 3. It is possible to improve the performance of tracking and the like by forming the reflective layer 2. Further, the quality of the recording signal can be improved by the quenching effect and by improving the reflectivity.

In the optical recording medium of the present invention having the above structure, the recording layer contacting the on-grooves 1a or opposing the in-grooves 1b is an optical recording portion. With this structure, it is possible to form a stable and clear recording mark on the recording layer. Further, for recording on the on-grooves, since the distance between the reflective layer and the recording layer is small, it is possible to form a clear recording mark due to a kind of heat sink effect since it is easy for heat from the laser recording portion to escape to the reflective layer. On the other hand, for recording on the in-grooves, since it is difficult for heat from the laser to escape, it is possible to obtain high sensitivity, and since cavity portions are formed between the reflective layer and the recording layer, decomposition of the recording layer can be accelerated and a high degree of modulation can be obtained.

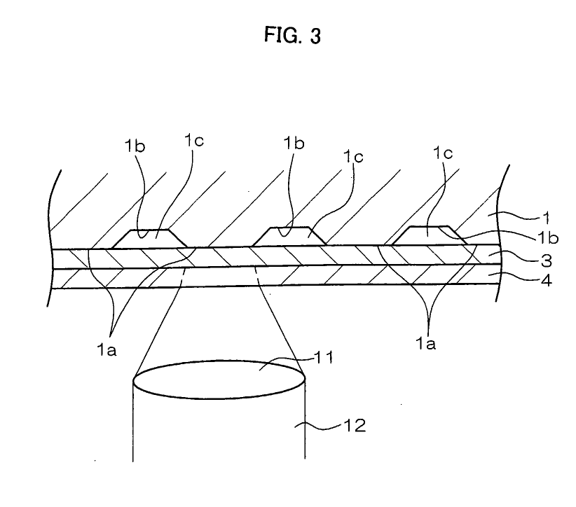

Further, FIG. 3 shows another example of the layer structure of an optical recording medium of the present invention. In addition, layers and components indicated with the same reference numbers in FIG. 2 and FIG. 3 respectively have the same functions and detailed description thereof is omitted.

As shown in FIG. 3, the recording layer 3 and the cover layer 4 are planar without concavities, convexities or curvature and are in total mutual contact at the respective contacting surfaces thereof. Further, the recording layer 3 contacts with the on-grooves 1a and does not contact with the in-grooves 1b, and portions of the recording layer that contact the on-grooves are a recording portion. Specifically, the surface of the recording layer 3 at the substrate side thereof is planar such that, within a pitch corresponding to the track pitch, concavities or convexities of 5 nm or more are not generated.

Further, cavity portions are formed between the in-grooves 1b and the recording layer 3 and, in the case of FIG. 2, the cavity portions are formed between the in-groove portions of the reflective layer 2 and the recording layer 3. It is preferable that the cavity portions 1c have any of a vacuum atmosphere, a reduced pressure atmosphere, a reduced pressure nitrogen atmosphere, or a reduced pressure inert gas atmosphere. With any of the above atmospheres, the optical recording medium can be sensitized because it becomes easier for cracked gas resulting from the pigments produced when information is recorded to be emitted. Such an effect can similarly be expected from other recording methods using alteration of shape such as a hole-formation type method. In addition, it is possible to eliminate or reduce atmospheres in cavity portions such as oxygen or moisture that might have an adverse influence on storability, which can be expected to favorably influence and improve in storage stability.

In order to provide the cavity portions 1c with any of the above atmospheres, any of the above atmospheres should be provided when, as discussed above, the substrate 1 on which a given reflective layer 2 is formed and a cover film corresponding to the cover layer 4 on which the recording layer 3 is formed are bonded together with an adhesive agent or the like. The atmosphere of the cavity portions 1c can be confirmed by mass spectroscopy analysis in a vacuum.

### Optical Recording Method and Optical Reproduction Method

In the following, a method of optically recording information onto an optical recording medium and a method of optically reproducing the recorded information according to the present invention are explained.

### Optical Recording Method

The optical recording method of the present invention records information at a recording portion of the recording medium of the present invention described above by focusing laser beam of wavelength 450 nm or less through an objective lens with a numerical aperture of 0.7 or more and irradiating from the cover layer side.

First, the optical recording medium of the present invention is, for example, rotated at constant line velocity (CLV) and laser beam is irradiated onto the recording portion from the cover layer side. The recording layer absorbs the irradiated laser beam causing localized temperature increases, and information is recorded by generation of physical or chemical changes that alter the optical properties.

The light source for the laser beam for the recording is not particularly limited as long as it is a light source that oscillates laser beam of wavelength 450 nm or less, and possible examples include a blue-violet semiconductor laser that has an oscillation wavelength in the range of 390-415 nm and a blue-violet SHG laser with a central oscillation wavelength of 425 nm.

Further, in order to increase recording density, the numerical aperture of the objective lens used for pick-up is 0.7 or above and, preferably 0.85 or above.

### Optical Reproduction Method

Information recorded at the recording portion is reproduced by focusing laser beam of wavelength 450 nm or less through an objective lens with a numerical aperture of 0.7 or more and irradiating from the cover layer side of the optical recording medium of the present invention, and then detecting the reflected light.

Specifically, similarly to the optical recording method, reproduction of information can be performed by irradiating laser beam from the cover film side while rotating the optical recording medium of the present invention at a constant line velocity. The entire disclosures of Japanese Application Nos. 2005-115869 and 2005-222123 are incorporated by reference herein.

### EXAMPLE

The present invention is explained in detail with reference to the following examples, but the present invention is not limited thereto.

### Example 1

A substrate of injection molded polycarbonate resin (polycarbonate manufactured by Teijin Chemicals Ltd.; trade name: Panlite® AD-5503) was provided, which has 1.1 mm thickness and a 120 mm diameter and has spiral grooves consisting of in-grooves and on-grooves (height of the on-groove portions: 40 nm, width of the on-groove portions: 120 nm; track pitch; 320 nm). A reflective layer with a thickness of 100 nm was formed by sputtering Ag on a surface having grooves of the substrate (reflective layer forming process).

A coating solution for forming a recording layer was prepared by mixing 12 g of a phthalocyanine organic compound dye A (Orasol® Blue GN manufactured by Ciba Specialty Chemicals; maximum absorption wavelength: 340 nm and 640 nm) with 1 liter of 2,2,3,3-tetrafluoropropanol and dissolving it by performing ultrasonic treatment for 2 hours.

The coating solution was web coated on a polycarbonate sheet (manufactured by Teijin Chemicals, LTD; trade name PURE-ACE®; thickness: 80 μm) which was a cover film and dried to produce a cover film on which a recording layer has been formed. Further, the drying was carried out in an atmosphere of 30° C. 45% RH during web conveyance.

The cover film was stamped out with a disk stamping machine having blades for stamping a center hole portion and an outline portion (hereinafter, the stamped cover film is referred to as the “cookie”). The recording layer of the cookie and the reflective layer of the substrate were opposed and bonded by vacuum adherence in a vacuum atmosphere of 3×10⁻³ Torr to produce an optical recording medium.

In addition, when bonding, an ultraviolet photocurable resin (SD-318, manufactured by Dainippon Ink and Chemicals, Inc.) was coated in advance at the edge portions of the inner and outer edges of the cookie and irradiated with ultraviolet light. The atmosphere inside the apparatus when bonding was a nitrogen atmosphere.

When a reproduction test was performed on the optical recording media produced by recording a 3T signal using a DDU-1000 (manufactured by Pulsetech Co., Ltd.) that oscillates 405 nm laser beam and then performing reproduction with 405 nm laser beam, and the variation of modulation amplitude along the radial direction and the degree of modulation were measured, the optical recording media of Examples 1-3 were superior to those of Comparative Example 1 in terms of recording sensitivity, reflectivity, degree of modulation, jitter, reduced variation of modulation amplitude along the radial direction and the circumferential direction in asymmetry, and recording and reproduction properties.

### INDUSTRIAL APPLICABILITY

According to the present invention, an optical recording medium with high reliability that can record at high density can be obtained according to a method of producing an optical recording medium at low cost and superior productivity. Accordingly, optical recording media produced according to the method of the present invention can be used as recording media such as a rewritable or recordable CD-Rs and DVD-Rs for use, for example, in computers, in business or by consumers.

1. A method for producing an optical recording medium comprising a substrate and a reflective layer, a recording layer and a cover layer formed in this order on the substrate, wherein the method comprises:
forming guide grooves or pits on the substrate,
forming the reflective layer at a surface side of the substrate on which the guide grooves or pits are formed,
forming the recording layer by forming a film on the cover layer, and
bonding the substrate on which the reflective layer is formed and the cover layer on which the recording layer is formed wherein the bonding is performed by bonding an innermost circumferential portion and an outermost circumferential portion of the cover layer without bonding a data-recording area.

2. The method for producing an optical recording medium of claim 1, wherein the bonding is performed in any one atmosphere of a vacuum atmosphere, a reduced pressure atmosphere, a reduced pressure nitrogen atmosphere, or a reduced pressure inert gas atmosphere.

3. The method for producing an optical recording medium of claim 1, wherein the film forming of the recording layer is performed by web coating.

4. The method for producing an optical recording medium of claim 2, wherein the film forming of the recording layer is performed by web coating.

5. The method for producing an optical recording medium of claim 1, wherein the film forming of the recording layer is performed by web vacuum deposition or sputtering.

6. The method for producing an optical recording medium of claim 2, wherein the film forming of the recording layer is performed by web vacuum deposition or sputtering.

7. The method for producing an optical recording medium of claim 1, wherein the guide grooves or pits are formed on one surface of the substrate.

8. The method for producing an optical recording medium of claim 1, wherein the guide grooves or pits are formed on both surfaces of the substrate and the forming of the guide grooves or pits is performed simultaneously on both surfaces.

9. (canceled)

10. (canceled)

11. The method for producing an optical recording medium of claim 1, wherein the bonding is performed after a dielectric layer is provided on the recording layer at the side of the cover layer.

12. (canceled)

13. A method for producing an optical recording medium comprising a substrate and at least a recording layer and a cover layer formed in this order on the substrate, wherein the method comprises:
simultaneously forming guide grooves or pits on one surface of the substrate and pits on another surface of the substrate,
forming the recording layer by forming a film on the cover layer,
bonding the cover layer on which the recording layer is formed to one surface side of the substrate such that the recording layer is an internal layer and bonding a cover layer on which no recording layer is formed to another surface side of the substrate.

14. The method for producing an optical recording medium of claim 13, wherein at least the bonding is performed in any one atmosphere of a vacuum atmosphere, a reduced pressure atmosphere, a reduced pressure nitrogen atmosphere, or a reduced pressure inert gas atmosphere.

15. The method for producing an optical recording medium of claim 13, wherein the film forming of the recording layer is performed by web coating.

16. The method for producing an optical recording medium of claim 14, wherein the film forming of the recording layer is performed by web coating.

17. The method for producing an optical recording medium of claim 13, wherein the film forming of the recording layer is performed by web vacuum deposition or sputtering.

18. The method for producing an optical recording medium of claim 14, wherein the film forming of the recording layer is performed by web vacuum deposition or sputtering.

19. The method for producing an optical recording medium of claim 1, wherein the recording layer includes a dye.

20. The method for producing an optical recording medium of claim 13, wherein the bonding is performed by:
bonding the cover layer on which the recording layer is formed to one surface side of the substrate on which the guide grooves or pits are formed such that the recording layer is an internal layer;
bonding the substrate on which the reflective layer is formed and the cover layer on which the recording layer is formed by bonding an innermost circumferential portion and an outermost circumferential portion of the cover layer without bonding a data-recording area; and
bonding the cover layer on which no recording layer is formed to another surface side of the substrate.

21. The method for producing an optical recording medium of claim 1, wherein when the innermost circumferential portion and the outermost circumferential portion are bonded, an ultraviolet photocurable resin is coated in advance at edge portions of the innermost circumferential portion and the outermost circumferential portion.
